(19) United States
(12) Patent Application Publication
(10) Pub. No.: US 2008/0011906 A1
(43) Pub. Date: Jan. 17, 2008

(54) CONNECTING STRUCTURE AND METHOD THEREOF

(75) Inventors: Chi-Chang Lin, Taipei City (TW); Chien-Che Ting, Taipei City (TW); Tai-Yu Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AMA PRECISION INC., Taipei (TW)

(21) Appl. No.: 11/773,972

(22) Filed: Jul. 6, 2007

(30) Foreign Application Priority Data
Jul. 14, 2006 (TW) 95125805

(51) Int. Cl. F16L 5/00

(52) U.S. Cl. 248/56

(57) ABSTRACT

A connecting structure for connecting a pipe-shaped element including a base and at least a lock element is provided. The base includes a first clamper, a second clamper and a spacer. The first clamper and the second clamper are connected together on one side while a gap is maintained between the first clamper and the second clamper on the other side to form a groove that connects with the spacer. One end of the pipe-shaped element is disposed inside the spacer. The first clamper has at least a lock hole and the second clamper has at least a corresponding second lock hole. The pipe-shaped element disposed inside the spacer is tightly assembled to the base by the lock element through the first lock hole and the second lock hole. Furthermore, a connecting method for connecting the pipe-shaped element is also provided.

### CROSS-REFERENCE TO RELATED APPLICATION

This application claims the priority benefit of Taiwan application serial no. 95125805, filed Jul. 14, 2006. All disclosure of the Taiwan application is incorporated herein by reference.

### BACKGROUND OF THE INVENTION

1. Field of the Invention

The present invention relates to a connecting structure, and more particularly, to a connecting structure for connecting a pipe-shaped element.

2. Description of Related Art

In the processing of electronic devices, it is quite common to use a reflow process to connect a pipe-shaped element to a connecting structure to achieve a definite purpose. FIG. 1 is a diagram of a conventional connecting structure for connecting a pipe-shaped element. As shown in FIG. 1, the pipe-shaped element 10 is connected to a through-hole 110 in the connecting structure 100 by a reflow process so that the end 12 of the pipe-shaped element 10 has a good connecting relation with the connecting structure 100. The foregoing connecting structure 100 is a copper plate of a heat sink module (not shown) and the pipe-shaped element 10 is a heat pipe of the heat sink module, for example.

However, in a reflow process, the reflow parameters are difficult to set so that solder overflow or missing solder frequently occurs in the areas between the connecting structure 100 and the pipe-shaped element 10. For example, the quantity of solder disposed between the end 12 of the pipe-shaped element 10 and the connecting structure 100 is difficult to control that a uniform coating between them rarely forms. As a result, solder overflow or missing solder in the areas between the connecting structure 100 and the pipe-shaped element 10 is a frequent occurrence after a reflow process. In other words, the yield of the connection between the connecting structure 100 and the pipe-shaped element 10 is poor and hence has a considerable influence on productivity.

In addition, the conventional technique requires a plating process to be performed on the connecting structure 100 and the pipe-shaped element 10 before carrying out the aforementioned reflow process so that the connecting structure 100 and the pipe-shaped element 10 can be connected together through solder material. Thus, the cost of connecting the pipe-shaped element 10 to the connecting structure 100 is increased.

### SUMMARY OF THE INVENTION

Accordingly, at least one objective of the present invention is to provide a connecting structure capable of resolving solder overflow or missing solder problem when connecting a pipe-shaped element to the connecting structure by soldering.

At least another objective of the present invention is to provide a method of connecting a pipe-shaped element to a connecting structure that can reduce the production cost.

To achieve these and other advantages and in accordance with the purpose of the invention, as embodied and broadly described herein, the invention provides a connecting structure suitable for connecting a pipe-shaped element. The connecting structure including a base and at least a lock element is provided. The base includes a first clamper, a second clamper and a spacer. The first clamper and the second clamper are connected on one side while a gap is maintained between the first clamper and the second clamper on the other side to form a groove connected to the spacer. One end of the pipe-shaped element is disposed inside the spacer. The first clamper has at least a lock hole and the second clamper has at least a corresponding second lock hole. The pipe-shaped element disposed inside the spacer is tightly assembled to the base by the lock element through the first lock hole and the second lock hole.

In one embodiment of the present invention, the spacer has a profile that corresponds to the shape of the end portion of the pipe-shaped element.

In one embodiment of the present invention, the lock element is a screw.

In one embodiment of the present invention, the base is fabricated using copper or aluminum.

The present invention also provides a method for connecting a pipe-shaped element, which includes the following steps. First, a base is provided. Then, one end of the pipe-shaped element penetrates through a spacer in the base. After that, the pipe-shaped element is tightly assembled to the base by the lock element through a first lock hole and a second lock hole.

In the present invention, one end of the pipe-shaped element is inserted into a spacer between the first clamper and the second clamper, and at least a lock element is used to lock the first clamper and the second clamper together. Hence, the pipe-shaped element disposed inside the spacer is tightly assembled to the base so that the purpose of connecting the pipe-shaped element to the connecting structure is achieved. Compared with the conventional technique, the method of connecting the pipe-shaped element to the connecting structure in the present invention does not lead to solder overflow or missing solder problem. In other words, there is a better yield relation between the connecting structure and the pipe-shaped element.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional connecting structure for connecting a pipe-shaped element.

FIG. 2A is a perspective view of a connecting structure for a pipe-shaped element according to one preferred embodiment of the present invention.

FIG. 2B is a perspective view showing the dissembled components of the connecting structure and pipe-shaped element in FIG. 2A.

FIGS. 3A through 3C show the process of assembling a pipe-shaped element to a connecting structure according to one preferred embodiment of the present invention.

FIG. 4 is a perspective view of another connecting structure for a pipe-shaped element according to one preferred embodiment of the present invention.

FIG. 5 is a heat sink module in an electronic device according to the present invention.

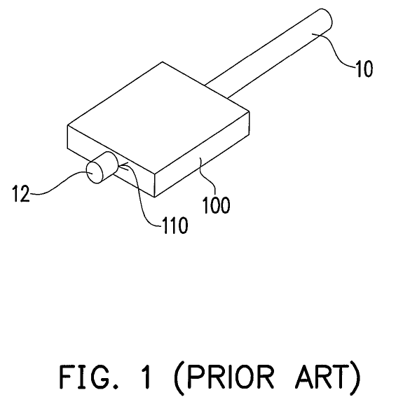

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

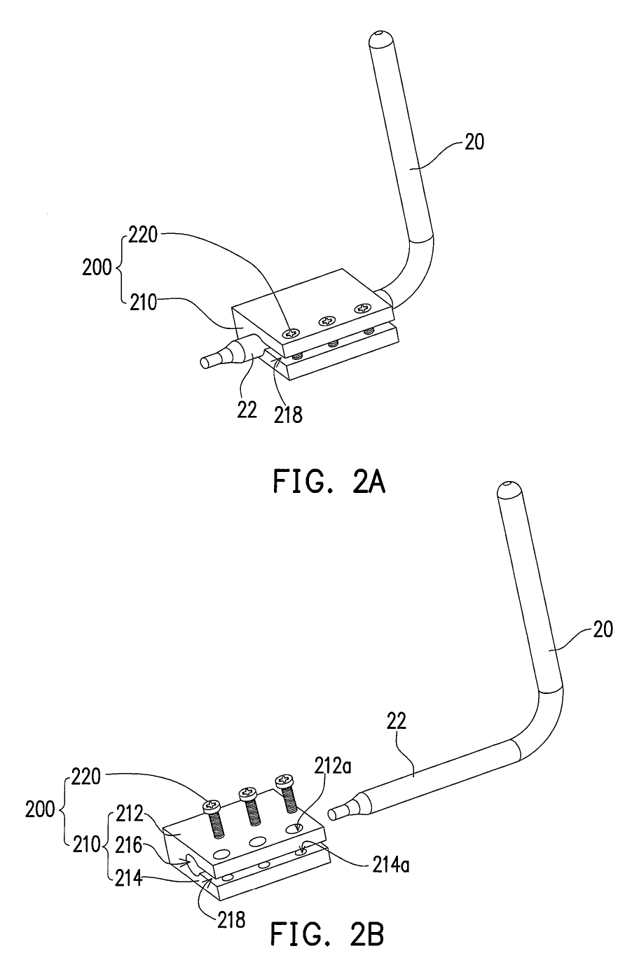

FIG. 2A is a perspective view of a connecting structure for a pipe-shaped element according to one preferred embodiment of the present invention. FIG. 2B is a perspective view showing the dissembled components of the connecting structure and pipe-shaped element in FIG. 2A. As shown in FIGS. 2A and 2B, the connecting structure 200 in the present embodiment is suitable for connecting a pipe-shaped element 20. The connecting structure 200 includes a base 210 and a plurality of lock elements 220 (three are shown in FIG. 2A). The base 210 has a first clamper 212, a second clamper 214 and a spacer 216. In the present embodiment, the first clamper 212 and the second clamper 214 are connected together on one side while a gap is maintained between the first clamper 212 and the second clamper 214 on the other side to form a groove 218 that connects with the spacer 216. One end 22 of the pipe-shaped element 20 is disposed inside the spacer 216.

In addition, the first clamper 212 has a plurality of first lock holes 212a (three are shown in FIG. 2A) and the second clamper 214 has a plurality of second lock holes 214a corresponding to the first lock holes 212a. In the present embodiment, the gap between the first clamper 212 and the second clamper 214 can be reduced so that the pipe-shaped element 20 disposed within the spacer 216 can be tightly assembled to the base 210 by the lock elements 220 through the first lock holes 212a and the second lock holes 214a. In other words, after locking the first clamper 212 and the second clamper 214 together through the plurality of lock elements 220, the pipe-shaped element 20 and the base 210 have a good connecting relation.

In one preferred embodiment, the lock elements 220 are screws or other suitable lock devices, for example. The base 210 is typically manufactured using a highly thermal conductive material including, for example, copper, aluminum or alloy. In addition, to provide a better connecting relation between the base 210 and the end 22 of the pipe-shaped element 20, the spacer 216 has a profile that corresponds to the shape of the end portion 22 of the pipe-shaped element 20, for example. In the present embodiment, because the end of the pipe-shaped element 20 has a circular shape, the spacer 216 is a cylindrical spacer. The shape and dimension of the cylindrical spacer corresponds to the end portion 22 of the pipe-shaped element 20 so that the end portion 22 of the pipe-shaped element 20 can be tightly assembled to the base 210.

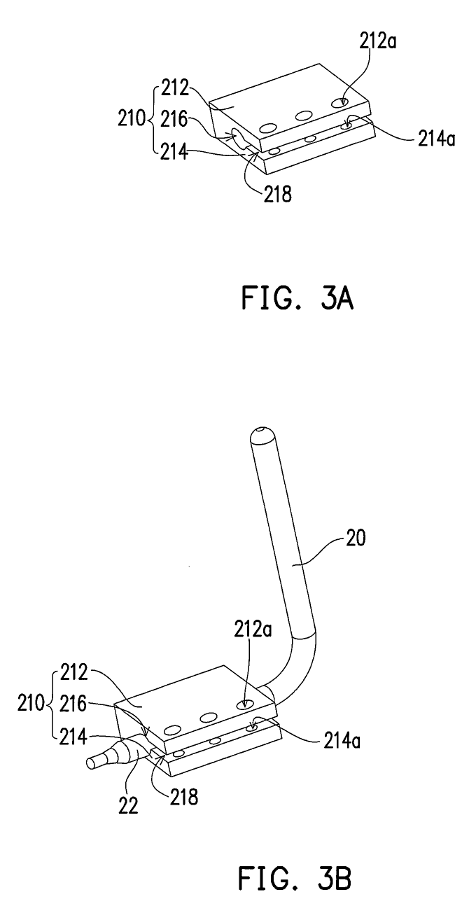

FIGS. 3A through 3C show the process of assembling a pipe-shaped element to a connecting structure according to one preferred embodiment of the present invention. First, as shown in FIG. 3A, the foregoing base 210 is provided. Then, as shown in FIG. 3B, one end 22 of the pipe-shaped element 20 is disposed inside the spacer 216. Thereafter, as shown in FIG. 3C, the lock element 220 passes from the first lock hole 212a through the groove 218 and locks to the second lock hole 214a (refer to FIG. 3B) so that the gap between the first clamper 212 and the second clamper 214 is reduced. In other words, the first clamper 212 and the second clamper 214 clamp the pipe-shaped element 20 disposed in the spacer 216 so that the pipe-shaped element 20 is tightly assembled to the base 210.

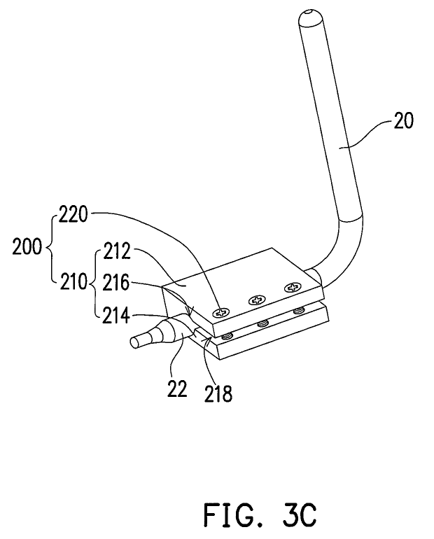

FIG. 4 is a perspective view of another connecting structure for a pipe-shaped element according to one preferred embodiment of the present invention. As shown in FIG. 4, the connecting structure 400 in the present embodiment is similar to the connecting structure 200 in the foregoing embodiment. One main difference is that the configuration of the base 410 in the present embodiment is different from the base 210 of the previous embodiment. In other words, the connecting structure 400 in the present embodiment similarly has a first clamper 412, a second clamper 414, a spacer 416 and a plurality of lock elements 420. The lock elements 420 lock the first clamper 412 and the second clamper 414 so that the end portion 42 of the pipe-shaped element 40 inserted into the spacer 416 are tightly assembled with the base 410. Hence, there is a better connection between the pipe-shaped element 40 and the connecting structure 400.

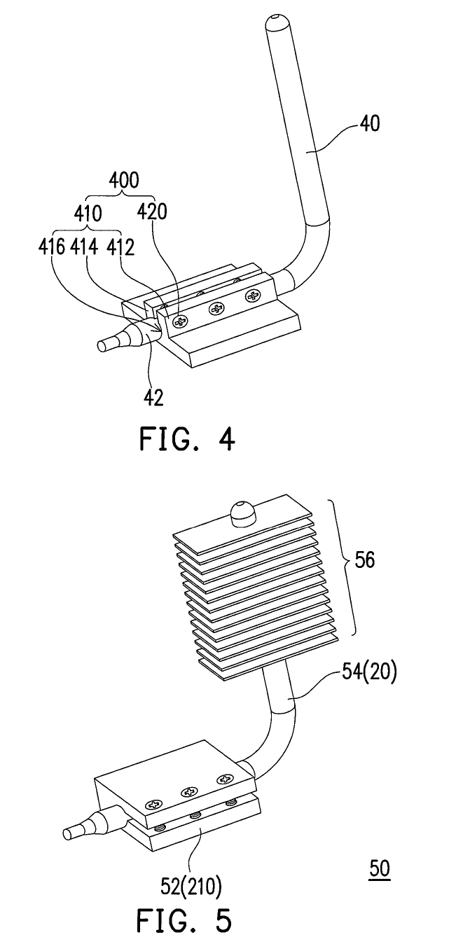

Accordingly, the connecting structure 200 (400) can be applied to a heat sink module 50 (as shown in FIG. 5) of a common electronic device. The base 210 is a base plate 52 and the pipe-shaped element 20 is a heat pipe 54, for example. Furthermore, in one preferred embodiment, a fins-assembly 56 may be disposed on the other end of the heat pipe 54. Because the base plate 52 and the heat pipe 54 have a good connecting relation, a heat source (not shown) in contact with the base plate 52 can transfer heat to the fins-assembly 56. As a result, the fins-assembly 56 can exchange heat with the surrounding air so as to lower the temperature of the heat source.

In summary, one end of the pipe-shaped element is inserted into a spacer between the first clamper and the second clamper and at least a lock element is used to lock the first clamper and the second clamper together in the present invention. Hence, the gap between the first clamper and the second clamper is reduced and the pipe-shaped element disposed inside the spacer is tightly assembled to the base so that the purpose of connecting the pipe-shaped element to the connecting structure is achieved. Compared with the conventional technique of using a reflow process to connect a pipe-shaped element to the connecting structure, the connecting structure in the present invention has at least the following advantages:

1. Because one end of the pipe-shaped element is inserted into the spacer of the connecting structure and a lock element is used to lock the first clamper and the second clamper to make the connection of the pipe-shaped element and the connecting structure, the present invention does not lead to solder overflow or missing solder problem. In other words, there is a better connection relation between the connecting structure and the pipe-shaped element.

2. Because a locking method is applied to connect the pipe-shaped element, there is no need to perform an electroplating process on the base and the pipe-shaped element (unless a reflow process to join the base and the pipe-shaped element is desired). Hence, the present invention is able to lower the production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connecting structure suitable for connecting a pipe-shaped element, the connecting structure comprising:
a base, having a first clamper, a second clamper and a spacer, one side of the first clamper and one side of the second clamper being connected together, a gap being maintained on the other side between the first clamper and the second clamper to form a groove that connects with the spacer, and one end of the pipe-shaped element being disposed in the spacer, wherein the first clamper has at least one first lock hole and the second clamper has at least one second lock hole corresponding to the first lock hole; and
at least one lock element, through the first lock hole and the second lock hole, the pipe-shaped element disposed in the spacer being tightly assembled to the base.

2. The connecting structure of claim 1, wherein the shape of the spacer corresponds to the profile of the end portion of the pipe-shaped element.

3. The connecting structure of claim 1, wherein the lock element comprises a screw.

4. The connecting structure of claim 1, wherein the base is made by copper or aluminum.

5. A method of connecting a pipe-shaped element, the method comprising:
providing a base, having a first clamper, a second clamper and a spacer, one side of the first clamper and one side of the second clamper being connected, and a gap being maintained on the other side between the first clamper and the second clamper to form a groove that connects to the spacer, wherein the first clamper has at least a first lock hole and the second clamper has at least a second lock hole corresponding to the first lock hole;
inserting one end of the pipe-shaped element into the spacer; and
using at least one lock element to lock the first clamper and the second clamper through the first lock hole and the second lock hole so that the pipe-shaped element disposed in the spacer is tightly assembled to the base.
